(19) United States
(12) Patent Application Publication
(10) Pub. No.: US 2026/0361194 A1
(43) Pub. Date: Nov. 12, 2026

(54) LINEAR OSCILLATORY MOTOR AND ELECTRIC CLEANING DEVICE

(71) Applicant: Jixi Yang, Dongguan City (CN)

(72) Inventor: Jixi Yang, Dongguan City (CN)

(21) Appl. No.: 19/646,454

(22) Filed: Apr. 13, 2026

(30) Foreign Application Priority Data
May 8, 2025 (CN) 202520899815.1

(51) Int. Cl. H02K 33/14; A61C 17/26

(52) U.S. Cl. CPC H02K 33/14; A61C 17/26

(57) ABSTRACT

The present disclosure belongs to the technical field of linear motors for electric toothbrushes, and discloses a linear oscillatory motor and an electric cleaning device, including: a housing, a permanent magnet assembly, the permanent magnet assembly being a plurality of permanent magnets provided on the housing at intervals, and the permanent magnet assembly being a stator; an armature, two sets of coils being provided axially on an iron core of the armature, and both ends of the iron core being connected to the housing via leaf springs, and being located above the permanent magnet assembly, the armature being a mover.

### CROSS REFERENCE TO RELATED APPLICATIONS

The present disclosure claims the priority of Chinese Patent Application No. 2025208998151 filed on May 8, 2025 before CNIPA. All the above are hereby incorporated by reference in their entirety.

### TECHNICAL FIELD

The present disclosure relates to the technical field of linear motors for electric toothbrushes, and in particular, to a linear oscillatory motor and an electric cleaning device.

### BACKGROUND

Linear oscillatory motors for electric toothbrushes in the prior art are single-coil linear oscillatory motors, and the single-coil linear oscillatory motors have a high load current, leading to relatively weak power and poor cleaning strength.

### SUMMARY

In view of the above, the present disclosure provides a linear oscillatory motor and an electric cleaning device for solving one of the problems in the background described above.

To achieve one, part, or all of the above objectives or other objectives, the present disclosure proposes a linear oscillatory motor, including:
a housing,
a permanent magnet assembly, where the permanent magnet assembly includes at least two permanent magnets provided on the housing at intervals, and the permanent magnet assembly is a stator;
an armature, where two sets of coils connected in series are provided axially on an iron core of the armature, both ends of the iron core are connected to the housing via leaf springs, and the armature is located above the permanent magnet assembly, where the armature is a mover;
a gap between the permanent magnets and comb-teeth portions of the iron core of the armature is set between 0.1 mm and 0.8 mm.

In some implementations, the linear oscillatory motor further includes:
an auxiliary module, where the auxiliary module is formed by connecting both ends of a counterweight to the housing via leaf springs.

In some implementations, a main body of the iron core of the armature is formed by mixed stacking of a four-tooth comb-shaped iron sheet and a six-tooth comb-shaped iron sheet, and two sets of coils are wound on two central teeth; where the iron sheet for connecting the leaf springs is a six-tooth comb-shaped iron sheet, two teeth on outer sides are shorter, and at least a portion of the outside of the two teeth on outer sides is provided with a connection tab.

In some implementations, a width of a tooth foot of a second tooth and a fifth tooth of the six-tooth comb-shaped iron sheet is equal to half of that of two middle tooth feet.

In some implementations, an outer side of a tooth adjacent to the two teeth on two sides in the six-tooth comb-shaped iron sheet tilts inward by 15 to 30 degrees.

In some implementations, the permanent magnet assembly includes three permanent magnets, and, in response to being in an initial position, a first magnet is located between a first tooth and a second tooth of the four-tooth comb-shaped iron sheet, a second magnet is located between the second tooth and a third tooth of the four-tooth comb-shaped iron sheet, and a third magnet is located between the third tooth and a fourth tooth of the four-tooth comb-shaped iron sheet.

In some implementations, an overall shape of the four-tooth comb-shaped iron sheet is an inverted trapezoid; the six-tooth comb-shaped iron sheet is formed by extending a tooth outward and connecting the tooth on each side of the four-tooth comb-shaped iron sheet.

In some implementations, a back of the permanent magnet assembly is provided with an iron sheet assembly, and the iron sheet assembly is fixed to the housing.

In some implementations, a height ratio of the two external teeth to the four middle teeth in the six-tooth comb-shaped iron sheet is between 1:2 and 1:3.

In some implementations, each of the leaf springs is provided with a center end thereof and an outer end thereof, and is spiraled from the center end thereof for at least one turn to the outer end thereof, and the outer end thereof is provided with at least two outer connection ends forming an angle of 80 to 100 degrees with a center of a circle, and the at least two outer connection ends are respectively connected to a bottom wall and a side wall of the housing in response to the leaf springs being connected to the housing.

In some implementations, the housing is trough-shaped, and a front end thereof is provided with a through hole for allowing a drive shaft to pass through to connect to the leaf springs.

To achieve one, part, or all of the above objectives or other objectives, the present disclosure further proposes an electric cleaning device, and the electric toothbrush is provided with the linear oscillatory motor according to any one of the preceding implementations.

Implementing the embodiments of the present disclosure leads to the following beneficial effects:

After adopting the linear oscillatory motor described above, since two sets of coils connected in series are arranged axially on the iron core of the armature, compared with a single coil, under the same power supply, meaning the battery is the same, the coil resistance increases, the current decreases, the output power remains unchanged, the power consumption is reduced, and the endurance is improved; under the condition of keeping the current the same, since the armature is a double coil, the output power is improved, and the cleaning strength is improved.

### BRIEF DESCRIPTION OF THE DRAWINGS

In order to more clearly illustrate the technical solutions in the embodiments of the present disclosure or in the prior art, the drawings used in the description of the embodiments or the prior art will be briefly described below. Obviously, the drawings in the following description are only some embodiments of the present disclosure. For those of ordinary skill in the art, other drawings may be obtained according to these drawings without creative efforts.

In the drawings:

FIG. 1 is a schematic structural diagram of a linear oscillatory motor according to an embodiment of the present disclosure;

FIG. 2 is a schematic structural diagram of an armature and an auxiliary module according to an embodiment of the present disclosure;

FIG. 3 is a schematic diagram of an installation structure of a permanent magnet assembly according to an embodiment of the present disclosure;

FIG. 4 is a schematic structural diagram of a leaf spring according to an embodiment of the present disclosure;

FIG. 5 is a schematic structural diagram of a four-tooth comb-shaped iron sheet according to an embodiment of the present disclosure;

FIG. 6 is a schematic structural diagram of a six-tooth comb-shaped iron sheet according to an embodiment of the present disclosure;

FIG. 7 is a schematic structural diagram of a six-tooth comb-shaped iron sheet according to another embodiment of the present disclosure;

FIG. 8 is a schematic cross-sectional view of the structure of a linear oscillatory motor according to an embodiment of the present disclosure;

FIG. 9 is a schematic diagram of an installation structure of an iron sheet assembly according to an embodiment of the present disclosure;

FIG. 10 is a schematic structural diagram of a linear oscillatory motor according to another embodiment of the present disclosure;

FIG. 11 is another view of FIG. 10.

Reference Numerals: 1, housing; 2, permanent magnet assembly; 3, armature; 31, iron core; 311, four-tooth comb-shaped iron sheet; 312, six-tooth comb-shaped iron sheet; 3121, connection tab; 32, coil; 4, leaf spring; 41, center end; 42, outer end; 421, outer connection end; 5, auxiliary module; 6, drive shaft; 7, iron sheet assembly.

### DETAILED DESCRIPTION

Unless otherwise defined, all technical and scientific terms used herein have the same meaning as commonly understood by one of ordinary skill in the art to which the present disclosure belongs; the terms used in the specification of the present disclosure herein are for the purpose of describing specific embodiments only and are not intended to limit the present disclosure; the terms “comprise” and “include” and any variations thereof in the specification and claims of the present disclosure and the above description of the drawings are intended to cover a non-exclusive inclusion. The terms “first”, “second”, etc. in the specification and claims of the present disclosure or the above drawings are used to distinguish different objects, not to describe a specific order.

Reference to “embodiments” herein means that a particular feature, structure, or characteristic described in connection with the embodiments may be included in at least one embodiment of the present disclosure. The appearances of the phrase in various places in the specification are not necessarily all referring to the same embodiment, nor are separate or alternative embodiments mutually exclusive of other embodiments. It is explicitly and implicitly understood by those skilled in the art that the embodiments described herein may be combined with other embodiments.

In order to enable those skilled in the art to better understand the solutions of the present disclosure, the technical solutions in the embodiments of the present disclosure will be clearly and completely described below in conjunction with the accompanying drawings.

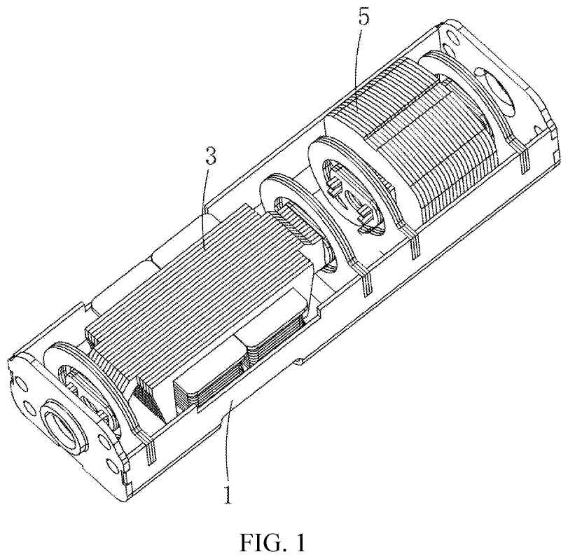

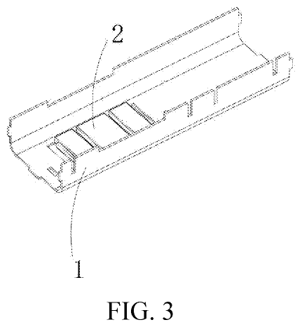

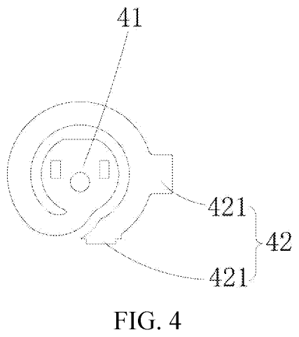

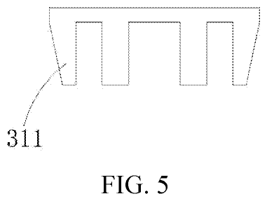

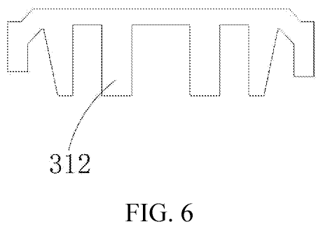

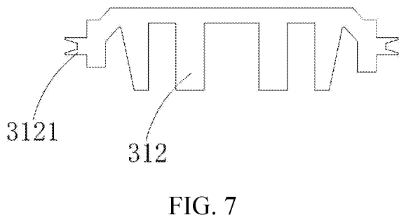

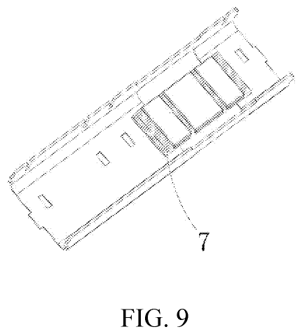

Referring to FIGS. 1 to 9, in some embodiments, the present disclosure provides a linear oscillatory motor including: a housing 1; a permanent magnet assembly 2, the permanent magnet assembly 2 including at least two permanent magnets provided at intervals on the housing 1, and the permanent magnet assembly 2 being a stator; an armature 3, two sets of coils 32 connected in series being provided axially on an iron core 31 of the armature 3, both ends of the iron core 31 being connected to the housing 1 via leaf springs 4 and located above the permanent magnet assembly 2, the armature 3 being a mover; a gap between the permanent magnets and comb-teeth portions of the iron core of the armature is set between 0.1 and 0.8 mm.

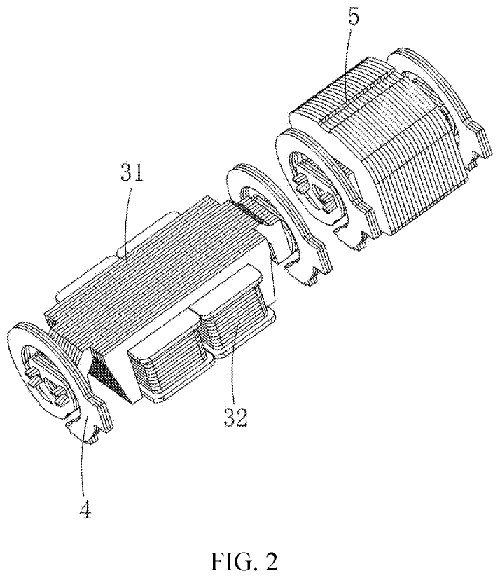

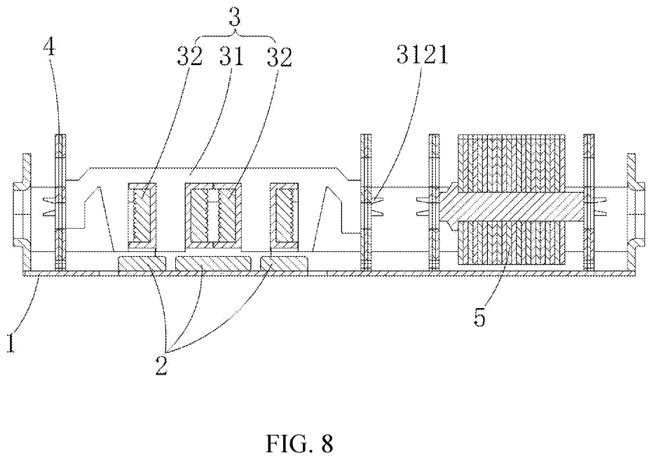

In the present embodiment, the housing 1 may be a trough-shaped housing 1, a bottom wall thereof being provided with some snapping structures for snapping the permanent magnets, or the permanent magnets may be directly adhered or fixed by other existing common methods. The aforementioned axial direction refers to a movement direction of the mover during operation, i.e., a length direction of a drive shaft 6. Providing two sets of coils 32 axially on the iron core 31 of the armature 3 means that two sets of coils 32 are provided on the iron core 31 of the armature 3, these two sets of coils 32 being arranged sequentially in the axial direction thereof, as shown in FIGS. 2 and 8. Since the armature 3 of the linear oscillatory motor serves as the mover and the permanent magnets serve as the stator, the permanent magnets may be directly provided on the housing 1; compared with existing linear oscillatory motors, no oscillating structure for carrying the permanent magnets is required, so less overall volume may be made. The aforementioned leaf springs may be one single leaf spring or a plurality of leaf springs stacked together. In addition, since the armature 3 serves as the mover, extended structures need to be provided at both ends of the iron core 31 of the armature 3 for connecting to the leaf springs 4; if connection shafts are directly extended from the iron core 31 of the armature 3, a magnetic field formed by the coils 32 would disperse towards the connection shafts, a magnetic force of the magnetic field formed by the coils 32 on the permanent magnets would weaken, leading to affecting efficiency and poor endurance; in the present embodiment, by providing two sets of coils 32, even if connection shafts are directly extended from the iron core 31 of the armature 3, adjacent portions of the two sets of coils 32 are not weakened, a degree of magnetic force weakening is greatly improved, which may better solve the aforementioned problem of poor endurance.

It is worth mentioning that under the same power supply, in response to the two coils being connected in series, compared to a single coil, a current is halved, but a total magnetomotive force (IN) remains unchanged, so an electromagnetic force is the same as that of the single coil. The following is a more detailed explanation:
1. For a single coil:

$$Load current : {I}_{single} = \frac{{Ud}^{4}}{ρ L ( D {2}^{2} - D {1}^{2} )} \times {10}^{3} \qquad ( A )$$

Electromagnetic force:

$${F}_{single} = \frac{{μ}_{0} {S}_{0}}{8} {( \frac{{d}^{2} U}{ρ ( D 2 + D 1 ) δ} )}^{2} \times {10}^{6} \qquad ( N )$$

2. For two coils connected in series:
Total resistance:

$${R}_{series} = 2 {R}_{single} = 2 \cdot ρ \frac{L ( D {2}^{2} - D {1}^{2} )}{{d}^{4}} \times {10}^{- 3} \qquad ( Ω )$$

Load current (current halved):

$${I}_{series} = \frac{U}{{R}_{series}} = \frac{{Ud}^{4}}{2 ρ L ( D {2}^{2} - {D}_{1}^{2} )} \times {10}^{3} = \frac{{I}_{single}}{2} \qquad ( A )$$

Total magnetomotive force (IN constant):

$${( IN )}_{series} = {I}_{series} \cdot 2 N = \frac{{I}_{single}}{2} \cdot 2 N = {I}_{single} \cdot N = {( IN )}_{single}$$

Electromagnetic force (same as that of the single coil): Fₛₑᵣᵢₑₛ=F_{single}
where:
ρ is resistivity;
L is winding width;
U is voltage;
D2 is the outer diameter of the winding;
D1 is the inner diameter of the winding; and
d is the diameter of the enameled wire.

From the above calculation process, it may be seen that under the same voltage, when two coils connected in series are employed, the load current is half of that of a single coil, and the electromagnetic force is the same as that of the single coil. Therefore, under the same power supply, the resistance of the two coils connected in series increases, the current decreases, and the output power remains unchanged, power consumption is reduced, and battery life is improved; under the condition of keeping the current the same, since the armature has double coils, the output power is improved, and cleaning strength is improved.

In some implementations, the linear oscillatory motor further includes:
an auxiliary module 5, the auxiliary module 5 being formed by connecting both ends of a counterweight to the housing 1 via leaf springs 4.

In the present embodiment, the overall structure and arrangement of the auxiliary module 5 are similar to those of the armature 3, the difference being that the auxiliary module 5 is not provided with coils 32, as shown in FIGS. 1, 2 and 8, the function of the auxiliary module 5 is to reduce the impact of the linear oscillatory motor on the vibration of the housing through resonance, improving user experience. In some implementations, the closer the mass of the counterweight is to the mass of the armature 3, the better.

In some implementations, the main body of the iron core 31 of the armature 3 is formed by mixed stacking of four-tooth comb-shaped iron sheets 311 and six-tooth comb-shaped iron sheets 312, two sets of coils 32 are wound on the two central teeth; where the iron sheets for connecting the leaf springs 4 are six-tooth comb-shaped, and two teeth on outer sides are shorter, and at least part of the outer side of the two teeth on outer sides is provided with connection tabs 3121.

In the present embodiment, the two sets of coils 32 are wound on the two central teeth, the specific positions are as shown in FIGS. 2 and 8. As mentioned above, providing a connection shaft on the iron core 31 of the armature 3 affects the magnetic field generated by the coils 32 to a certain extent, in the present embodiment, it is formed by mixed stacking of four-tooth comb-shaped iron sheets 311 and six-tooth comb-shaped iron sheets 312, as shown in FIG. 2, compared to being entirely formed by stacking six-tooth comb-shaped iron sheets 312, the connection shaft is smaller, and the above-mentioned magnetic field influence is reduced.

In some implementations, widths of the tooth feet of the second tooth and the fifth tooth in the six-tooth comb-shaped iron sheets are equal to half of the width of the two central tooth feet.

In some implementations, the outer side edges of the teeth adjacent to the two teeth on outer sides in the six-tooth comb-shaped iron sheets 312 are inclined inward by 15 to 30 degrees.

In the present embodiment, the outer sides of the teeth adjacent to the two teeth on outer sides in the six-tooth comb-shaped iron sheet 312 are inclined inward by 15 to 30 degrees. Compared to directly extending and providing a connection shaft on the iron core 31 of the armature 3, this manner causes the main body of the armature 3 to be away from the connection shaft, and the degree of weakening of the magnetic field generated by the coils 32 by the connection shaft is significantly reduced, and when applied to an electric toothbrush, it may effectively improve the battery life.

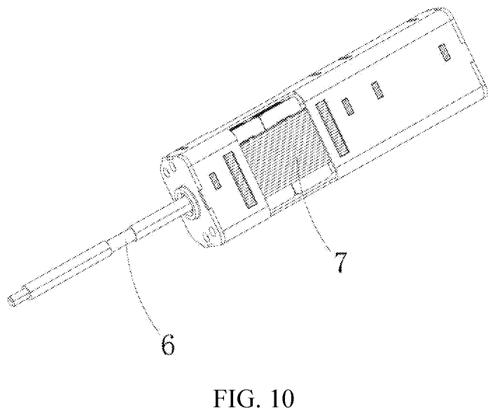

In some implementations, the permanent magnet assembly 2 is three permanent magnets, and the first magnet is located between the first tooth and the second tooth of the four-tooth comb-shaped iron sheet 311, the second magnet is located between the second tooth and the third tooth of the four-tooth comb-shaped iron sheet 311, and the third magnet is located between the third tooth and the fourth tooth of the four-tooth comb-shaped iron sheet 311 in response to being at the initial position. In addition, an iron sheet assembly 7 is provided at the back of the permanent magnet assembly, as shown in FIG. 10, the iron sheet assembly 7 is directly fixed to the housing, and providing the iron sheet assembly 7 may reduce magnetic leakage.

In the present embodiment, referring to FIG. 8, the permanent magnet assembly 2 is three permanent magnets, and the first magnet is located between the first tooth and the second tooth of the four-tooth comb-shaped iron sheet 311, the second magnet is located between the second tooth and the third tooth of the four-tooth comb-shaped iron sheet 311, and the third magnet is located between the third tooth and the fourth tooth of the four-tooth comb-shaped iron sheet 311 in response to being at the initial position. The second tooth and the third tooth are provided with coil windings, and the winding manner of the coils causes the ends of the first tooth, the second tooth, the third tooth, and the fourth tooth to generate virtual magnetic poles in a manner of alternating distribution of N poles and S poles. For example, causing the ends of the first tooth, the second tooth, the third tooth, and the fourth tooth to sequentially form N pole, S pole, N pole, S pole or S pole, N pole, S pole, N pole, and the end surfaces of the two coil winding modules facing the permanent magnets alternately form changes of N poles and S poles in response to alternating current being supplied to the linear oscillatory motor. At this time, according to the principle that like magnetic poles repel each other and unlike magnetic poles attract each other, attraction and repulsion phenomena are generated between the permanent magnets and the two coil winding modules (for example, the two like-pole magnets are like having a force to separate them in response to two like poles of two magnets approaching each other, due to the repulsive effect of the magnetic field, and two unlike-pole magnets attract and approach each other), causing the two coil winding modules to simultaneously apply substantially the same repulsive force or attractive force to both sides of the mover module along the width direction of the housing, improving the magnetoelectric reaction and causing the mover module to be force-balanced in the width direction of the housing, avoiding the mover module from generating offset along the width direction of the housing, ensuring structural stability, and achieving increasing the motor impedance of the linear oscillatory motor in a limited space, reducing the working current of the linear oscillatory motor, thereby reducing the power consumption of the linear oscillatory motor, and further extending the battery life of the linear oscillatory motor without increasing the battery capacity; and cooperating with the deformation and elastic restoring force of the two leaf spring assemblies, achieving oscillatory output along the axial direction while not easily generating oscillatory consumption along the width direction of the housing, thereby achieving reducing unnecessary waste of power consumption of the linear oscillatory motor while stably outputting axial reciprocating oscillation, and improving the battery life of products equipped with the linear oscillatory motor while improving customer use feeling and experience.

In some implementations, an overall shape of the four-tooth comb-shaped iron sheet 311 is an inverted trapezoid; the six-tooth comb-shaped iron sheet 312 is formed by extending a tooth outward and connecting the tooth on each side of the four-tooth comb-shaped iron sheet 311.

In some implementations, the height ratio between the two external teeth and the four middle teeth of the six-tooth comb-shaped iron sheet 312 is between 1:2 and 1:3.

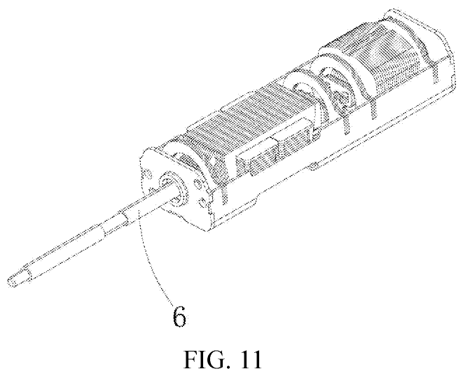

In the present embodiment, the leaf springs 4 are connected to the two side teeth of the six-tooth comb-shaped iron sheet 312, and the drive shaft 6 of the electric toothbrush is connected to the center end 41 of the leaf springs 4 in response to being applied to an electric toothbrush, as shown in FIG. 10 or FIG. 11. The height ratio between the two external teeth and the four middle teeth of the six-tooth comb-shaped iron sheet 312 is between 1:2 and 1:3, and there is at least one advantage, one is that with such a ratio setting, the drive shaft 6 is closest to or substantially the center of the armature 3, and since the thickness of the permanent magnets is really thin relative to the armature 3, the drive shaft 6 being close to the center of the armature 3 is close to the center of the linear oscillatory motor. The linear oscillatory motor is provided at the center of the housing 1 of the electric toothbrush in response to this proportional relationship being applied to an electric cleaning device such as an electric toothbrush, the drive shaft 6 is close to the central axis of the toothbrush, the overall proportion is more coordinated, the center of gravity is better, reducing the vibration feeling caused by oscillation during product use, and improving user experience.

In some implementations, each of the leaf springs 4 is provided with a center end 41 thereof and an outer end 42 thereof, and is spiraled at least one circle from the center end 41 to the outer end 42, and the outer end 42 is provided with two outer connection ends 421 forming an angle of 80 to 100 degrees with the center of a circle. The outer connection ends 421 are connected to the bottom wall and the side wall of the housing 1 respectively in response to the leaf spring 4 being connected to the housing 1.

In the present embodiment, since the armature 3 is connected to the two leaf springs 4 having center ends 41, the setting manner of the two outer connection ends 421 of the outer ends 42 causes the armature 3 to form a four-leg connection structure with four outer connection ends 421. The armature 3 is a two-leg connection structure if only one outer connection end 421 is provided at the outer end 42, and the stability is much worse than the above four-leg connection structure.

In some implementations, the housing 1 is trough-shaped, and the front end is provided with a through hole for the drive shaft 6 to pass through and connect to the leaf springs 4.

To achieve one or part or all of the above purposes or other purposes, the present disclosure further proposes an electric cleaning device, and the electric toothbrush includes the linear oscillatory motor according to any one of the above.

Obviously, the embodiments described above are only a part of the embodiments of the present disclosure, not all embodiments, and the drawings show preferred embodiments of the present disclosure, but do not limit the patent scope of the present disclosure. The present disclosure may be implemented in many different forms, and conversely, the purpose of providing these embodiments is to make the understanding of the disclosure of the present disclosure more thorough and comprehensive. Although the present disclosure has been described in detail with reference to the foregoing embodiments, for those skilled in the art, they may still modify the technical solutions described in the foregoing specific implementations, or equivalently replace some of the technical features. Any equivalent structure made by using the specification and drawings of the present disclosure, directly or indirectly applied in other related technical fields, is similarly within the protection scope of the patent of the present disclosure.

What is claimed is:

1. A linear oscillatory motor, comprising:
a housing,
a permanent magnet assembly, wherein the permanent magnet assembly comprises at least two permanent magnets provided on the housing at intervals, and the permanent magnet assembly is a stator;
an armature, wherein two sets of coils connected in series are provided axially on an iron core of the armature, both ends of the iron core are connected to the housing via leaf springs, and the armature is located above the permanent magnet assembly, wherein the armature is a mover;
wherein a gap between the permanent magnets and comb-teeth portions of the iron core of the armature is set between 0.1 mm and 0.8 mm.

2. The linear oscillatory motor according to claim 1, wherein the linear oscillation motor further comprises: an auxiliary module, wherein the auxiliary module is formed by connecting both ends of a counterweight to the housing via leaf springs.

3. The linear oscillatory motor according to claim 1, wherein a main body of the iron core of the armature is formed by mixed stacking of a four-tooth comb-shaped iron sheet and a six-tooth comb-shaped iron sheet, and the two sets of coils are wound on two central teeth; wherein an iron sheet for connecting the leaf springs is the six-tooth comb-shaped iron sheet, two teeth on outer sides are shorter, and at least a portion of the outside of the two teeth on outer sides is provided with a connection tab.

4. The linear oscillatory motor according to claim 3, wherein a width of a tooth foot of a second tooth and a fifth tooth of the six-tooth comb-shaped iron sheet is equal to half of that of two middle tooth feet.

5. The linear oscillatory motor according to claim 3, wherein the permanent magnet assembly comprises three permanent magnets, and, in response to being in an initial position, a first magnet is located between a first tooth and a second tooth of the four-tooth comb-shaped iron sheet, a second magnet is located between the second tooth and a third tooth of the four-tooth comb-shaped iron sheet, and a third magnet is located between the third tooth and a fourth tooth of the four-tooth comb-shaped iron sheet.

6. The linear oscillatory motor according to claim 1, wherein a back of the permanent magnet assembly is provided with an iron sheet assembly, and the iron sheet assembly is fixed to the housing.

7. The linear oscillatory motor according to claim 1, wherein each of the leaf springs is provided with a center end thereof and an outer end thereof, and is spiraled from the center end thereof for at least one turn to the outer end thereof, and the outer end thereof is provided with at least two outer connection ends forming an angle of 80 to 100 degrees with a center of a circle, and the at least two outer connection ends are respectively connected to a bottom wall and a side wall of the housing in response to the leaf springs being connected to the housing.

8. The linear oscillatory motor according to claim 7, wherein the permanent magnet assembly comprises three permanent magnets provided on the housing at intervals, and two outer connection ends are provided.

9. The linear oscillatory motor according to claim 1, wherein the housing is trough-shaped, and a front end thereof is provided with a through hole for allowing a drive shaft to pass through to connect to the leaf springs.

10. An electric cleaning device, wherein the electric cleaning device comprises a linear oscillatory motor, the linear oscillatory motor comprising:
a housing,
a permanent magnet assembly, wherein the permanent magnet assembly comprises at least two permanent magnets provided on the housing at intervals, and the permanent magnet assembly is a stator;
an armature, wherein two sets of coils connected in series are provided axially on an iron core of the armature, both ends of the iron core are connected to the housing via leaf springs, and the armature is located above the permanent magnet assembly, wherein the armature is a mover;
wherein a gap between the permanent magnets and comb-teeth portions of the iron core of the armature is set between 0.1 mm and 0.8 mm.

11. The electric cleaning device according to claim 10, wherein the linear oscillation motor further comprises: an auxiliary module, wherein the auxiliary module is formed by connecting both ends of a counterweight to the housing via leaf springs.

12. The electric cleaning device according to claim 10, wherein a main body of the iron core of the armature is formed by mixed stacking of a four-tooth comb-shaped iron sheet and a six-tooth comb-shaped iron sheet, and the two sets of coils are wound on two central teeth; wherein an iron sheet for connecting the leaf springs is the six-tooth comb-shaped iron sheet, the two teeth on outer sides are shorter, and at least a portion of the outside of the two teeth on outer sides is provided with a connection tab.

13. The electric cleaning device according to claim 12, wherein a width of a tooth foot of a second tooth and a fifth tooth of the six-tooth comb-shaped iron sheet is equal to half of that of two middle tooth feet.

14. The electric cleaning device according to claim 12, wherein the permanent magnet assembly comprises three permanent magnets, and, in response to being in an initial position, a first magnet is located between a first tooth and a second tooth of the four-tooth comb-shaped iron sheet, a second magnet is located between the second tooth and a third tooth of the four-tooth comb-shaped iron sheet, and a third magnet is located between the third tooth and a fourth tooth of the four-tooth comb-shaped iron sheet.

15. The electric cleaning device according to claim 10, wherein a back of the permanent magnet assembly is provided with an iron sheet assembly, and the iron sheet assembly is fixed to the housing.

16. The electric cleaning device according to claim 10, wherein each of the leaf springs is provided with a center end thereof and an outer end thereof, and is spiraled from the center end thereof for at least one turn to the outer end thereof, and the outer end thereof is provided with at least two outer connection ends forming an angle of 80 to 100 degrees with a center of a circle, and the at least two outer connection ends are respectively connected to a bottom wall and a side wall of the housing in response to the leaf springs being connected to the housing.

17. The electric cleaning device according to claim 16, wherein the permanent magnet assembly comprises three permanent magnets provided on the housing at intervals, and two outer connection ends are provided.

18. The electric cleaning device according to claim 10, wherein the housing is trough-shaped, and a front end thereof is provided with a through hole for allowing a drive shaft to pass through to connect to the leaf springs.
